(19) United States
(12) Patent Application Publication
(10) Pub. No.: US 2026/0148033 A1
(43) Pub. Date: May 28, 2026

(54) METHOD FOR MANUFACTURING A RADIO FREQUENCY SMART CARD COMPRISING A METAL PLATE WITH A SLOT IN THE PLATE

(71) Applicant: THALES DIS FRANCE SAS, MEUDON (FR)

(72) Inventors: Sébastien SUBRA, AURIOL (FR); Frédérick SEBAN, AURIOL (FR); Yeow Chun Ricky CHOO, Singapore (SG); Antoine BAJOLLE, Singapore (SG); Lucie TIBILETTI, La Ciotat (FR); Claude COLOMBARD, Pertuis (FR)

(73) Assignee: THALES DIS FRANCE SAS, MEUDON (FR)

(21) Appl. No.: 17/781,065

(22) PCT Filed: Nov. 25, 2020
(86) PCT No.: PCT/EP2020/083401

§ 371 Date: Dec. 17, 2025

(30) Foreign Application Priority Data
Dec. 2, 2019 (EP) 19306548.9

(51) Int. Cl. G06K 19/077

(52) U.S. Cl. CPC G06K 19/07794; G06K 19/07722; G06K 19/07747

(57) ABSTRACT

Provided is a method for manufacturing a radio frequency smart card comprising the step of forming a card body containing a metal plate forming a loop around a recess for receiving an antenna substrate, a slot extending from the recess to the periphery of the plate through the loop or the plate, said slot being filled with an insulating filler material, the method being characterized in that said filler material is obtained by the material of a tongue-shaped protrusion of the antenna substrate and formed with said antenna substrate before its insertion into the card. Other embodiments also relates to an antenna substrate and a corresponding card obtained by the method.

### FIELD OF THE INVENTION

The invention relates to a method of manufacturing a radio frequency smart card comprising a metal plate with a slot in the plate.

It further relates to the field of contactless metal smart cards with a slot comprising radiofrequency integrated circuit chip modules.

It is aimed in particular at the manufacture of smart cards comprising one or more metal sheets or plates.

The intended smart cards can be of the hybrid type (contact and contactless) or purely contactless (without electrical contacts).

Smart cards can have a smart card module comprising, on an insulating substrate, a radiofrequency transponder comprising the chip and the antenna. These radiofrequency smart card modules are generally embedded in a cavity of the card body. Alternatively, only the contact terminal block is mounted, the chip being on a separate printed circuit from the terminal block support.

The invention is aimed more particularly at bank cards comprising a predominantly metal body. The metal can preferably extend and be visible on at least one (or all) sides of the card body

### PRIOR ART

Patent FR 2743649 describes a smart card module, with antenna and/or contact pads, which can be incorporated into a card body cavity or can form an electronic RFID tag.

Patent EP1031939 (B1) describes a radiofrequency (or contactless) card comprising a coiled figure-eight relay antenna housed in a card body and electromagnetically or inductively coupled with the module antenna. The relay antenna comprises a narrow coil concentric with the module antenna and a wide coil to pick up the electromagnetic field from a reader.

Furthermore, hybrid radiofrequency devices, such as contact and contactless cards, are also known, comprising a contact smart card module incorporated into a card body and connected to an antenna housed in the card body.

In addition, there are bank cards comprising metal elements inserted inside the plastic card body or on the outer surface of the card body, such as aluminum, titanium, and gold. The metal provides a heavy feel to the card that is much appreciated by users. It also gives a visible aesthetic aspect that makes it a high-end product for the privileged.

Contactless metal cards are also known, with metal plates having a slot (or air gap).

US2019286961 describes a method of manufacturing a transaction device comprising the steps of forming a metal frame defining an outer periphery, an inner periphery defined by a cavity and at least one body slot extending from the outer periphery to the inner periphery of the metal frame, inserting a component with an RFID module into the cavity, filling the cavity and slot with a colorable insulating molding material.

Application US2019197386 describes a contactless smart card with one or more metal radio frequency coupling frames. The frames may comprise a slot and cavity extending across their width from the cavity to the peripheral edge of the card or metal frame. The cavity comprises a radio frequency module and the slot may comprise a filler material in the form of an active or inactive resin.

US2017308785 describes a contactless smart card with a metal plate, in the form of a slotted ring, having a recess for receiving a radio frequency module. The slot can be filled with a protrusion attached to a sheet portion supporting an antenna substrate.

### TECHNICAL PROBLEM

There is currently an increased public demand for heavy-duty smart cards that incorporate metallic materials. However, the presence of metal strongly interferes with radiofrequency communication, and manufacturing methods to obtain cards that comply with current smart card standards are more complex.

One of the applicant's solutions is to generate a slot in a metal plate that prevents the RF signal from being blocked by the metal or improves performance.

The disadvantage of this is that it is necessary to fill it with an additional step of deposition or filling of the material. Sometimes this filling operation is not so easy because the slot can be relatively thin, less than (or about) 0.8 mm.

Furthermore, the metal slot may have an opening in the metal that is clearly seen as a defect on the edge of the card when the metal extends to the edge of the card or through the outer covering layers of the card.

Furthermore, the slot may extend into a recess in the plate containing a substrate supporting electrical/electronic circuits and/or an antenna. A gap may exist between the inner edge of the recess and the peripheral or outer edge of the supporting substrate (of the card body antenna). Depending on the thickness of the outer cover layers, this gap and slot may be visible from the outside by transparency to light through the main surface of the card body.

In some cases, even if the slot does not open onto the edge of the card (a less preferred but possible case of the invention, with the plate recessed from the edge of the card), with the plate not extending to the edge, the slot and gap may be visible through the main surface of the card and constitute a visual defect.

The purpose of the invention is to provide an easy (or simplified) method of manufacturing smart cards with a metal plate comprising said slot.

Preferably, the intended card may not have these visual defects.

In particular, the invention is directed to a card structure with a hybrid or purely radiofrequency (RF) electronic chip module.

The card can also have a structure that satisfies ISO constraints of mechanical strength and durability over time. Such cards can be compliant with the ISO 78016 and/or ISO/IEC 14443 standard or equivalent to perform contact and/or proximity communication exchanges with a contact or NFC type reader.

The invention also provides a metal card structure with visible metal edges that provides maximum weight and good RF performance while being easy to manufacture. Preferably the card does not have the visual defects mentioned above.

The invention aims at solving the above-mentioned drawbacks or objectives.

### SUMMARY OF THE INVENTION

The metal used for the slotted card plate can be stainless steel with an occasionally shiny metallic effect on the edge of the card.

The invention proposes in its preferred principle to make the slot filling material of the same material as that of an antenna support housed in a slot inside a metal plate of the card.

Specifically, to facilitate manufacturing, the method includes cutting or producing or providing an antenna substrate (or support) with a protrusion or tongue corresponding to the slot. The tongue is attached to this substrate. The antenna substrate (with its tongue) is inserted or made into a slot in the card body plate in one operation. This makes it easier to fill the metal slot in a single operation or to avoid assembly errors.

This approach to the invention is very delicate and quite unusual in the field of smart cards, considering the manufacturing and positioning tolerances of the antenna substrate in a recess or housing of the metal plate.

In general, a module embedding in a card body cavity is done with a fairly compact module without protrusions or tongues.

The advantage of the invention is that the antenna substrate can be cut with the tongue in a single operation.

The invention avoids the need for two separate elements to be handled and inserted separately or distinctly into their respective housings.

Because the tongue is connected to the substrate, there is no risk of losing the tongue. The direction of insertion is easier to identify and thus avoid insertion errors.

The tongue can be a way to ensure correct orientation when inserted.

To facilitate insertion, the invention can provide for a wider slot, for example up to 2 mm or even 3 or 4 mm. However, this width is still very narrow in proportion to the width of an antenna module or support which is about 1 cm wide. The width ratio of the tongue can be for example less than ⅓ that of an antenna substrate.

The invention incidentally proposes to fill or mask this slot with a material that generates less visual gaps on the edge of the card with the metal. In one embodiment, a material with a gray color compared to a stainless steel plate can be used.

The manufacturing method of the invention may preferably provide for using material from a tongue-shaped protrusion of a antenna substrate. That protrusion can be cut with said antenna substrate and the assembly (substrate, protrusion, antenna) is then inserted inside a metal plate recess (or space) communicating with said slot up to the plate periphery. The antenna substrate and/or tongue are formed outside the recess before being inserted into the recess. The protrusion can at least partially fill the slot along the length and/or thickness. Additional material can be added by various means, in particular by making the surrounding material flow.

Alternatively, the tongue can be fastened to the antenna substrate by an adhesive or any other fastening means (tape, glue, etc.). Thus, once attached, the tongue thus formed as a protrusion of the antenna substrate can be inserted into the slot at the same time and in the same operation as the insertion of the antenna substrate into its recess in the metal plate.

Furthermore, the same selected substrate can have a material of the same color or chromaticity (defined by its color difference in DE94 (2, 1, 1) mode) lower (or ΔE*94) as the metal plate and allows the insertion of the antenna substrate and the filling of the slot in one operation.

Alternatively, only the tongue attached to the antenna substrate can be the same color as the antenna substrate. The tongue may or may not have a homogeneous continuity of material. If cut at the same time as the antenna substrate, the tongue may have the same material and exhibit material continuity. Conversely, if the tongue is cut separately but attached for ease of insertion, the tongue may or may not be of the same material and have a discontinuity at their interface. For example, the tongue can be made of PVC like the antenna substrate.

The important thing is to facilitate the insertion of the tongue into the slot of the metal plate by keeping the tongue attached to the antenna substrate while placing the antenna substrate in its slot.

If necessary, to facilitate cutting the protrusion, handling it and inserting it into the slot, the invention provides for intentionally increasing the width of the slot. For example, this width can be doubled or tripled to between 0.7 mm and 3 mm.

To this end, the invention relates to a method for manufacturing a radio frequency smart card comprising the step of forming a card body containing a metal plate forming a loop around a recess for receiving an antenna substrate, a slot extending from the recess to the periphery of the plate through the loop or plate and interrupting a metal path around the recess, said slot being filled with an insulating filler material.

The method is characterized in that said filler material is obtained at least partially from material of a tongue-shaped protrusion of the antenna substrate and formed with said antenna substrate before its insertion into the card.

The invention further makes it possible to eliminate or attenuate the visual defect on the edge of the card when the slot opens on the edge.

Thus, the method facilitates the filling of the slot in a single insertion operation at the same time as the insertion of the antenna substrate into the recess of the plate.

According to other features of the method:
The tongue-shaped protrusion attached to the antenna substrate is cut with said antenna substrate into an intermediate main substrate or is molded into said recess in particular. The position and shape of the tongue corresponds to the position and shape of said slot in said plate;
It comprises a step of inserting the antenna substrate inside the recess and inserting the tongue inside said slot in a single operation;
Said slot can be filled with a material having an opacity (or light transmission) coefficient close to at least 80% of that of the metal plate and/or with a material having a colorimetric deviation less than 10% from said the plate.

Also, the invention makes it possible to have a thin external cover sheet thickness in favor of a maximum metal plate thickness and with minimal visual defect by transparency through the card, coming from the assembly gap of the plate with a supporting substrate in the recess or slot.

Furthermore, since the outer layers may be transparent or translucent, there may be a visible discontinuity in the color or appearance of the metal plate and the antenna inlay. By having a tone-on-tone continuity of appearance between the metal plate and the insert, externally visible appearance defects are greatly mitigated.
A film, adhesive or resin having an opaque material or being of a color close to that of the metal plate, may be disposed in line with the slot or gap between the peripheral edge of the antenna substrate and the inner edge of the plate recess, on at least one of the major sides of said plate.

The method may further comprise the following steps of:
forming a metallic insert of a card body containing said plate in the form of a loop around a recess permeable to the radio frequency field opening out on the two main faces of said plate, said plate extending or not to at least one of the edges of the card,
inserting a relay antenna or a transponder antenna inside and/or opposite this space,
arranging a module equipped or not with a radio frequency module antenna, on the card body opposite the relay antenna or transponder antenna connection pads for a radio frequency coupling with the relay antenna or for an electrical connection with the transponder antenna;
The relay antenna or transponder antenna can be produced on said intermediate support substrate with a plurality of relay antennas or transponder antennas, each relay antenna or transponder antenna being then individualized with its own support substrate and said tongue-shaped protrusion, by extracting or cutting from the intermediate main antenna substrate;
It may preferably comprise a step of covering each opposite main face of said plate by at least one external covering layer.

The invention further relates to an antenna substrate configured to be inserted into a radio frequency smart card recess, said recess opening onto the periphery of the card through a slot, said card comprising a metal plate forming a loop around the recess, said slot extending from the recess to the periphery of the plate through the loop or the plate,
characterized in that said antenna substrate comprises a tongue-shaped protrusion to provide at least material to at least partially fill said slot and to form a homogeneous continuity of the antenna support substrate material.

According to other features,
The card comprises said antenna substrate according to the previous claim inserted inside the recess and a tongue inserted inside said slot;
Said slot can be filled with a material having an opacity coefficient close to at least 80% of that of the metal plate and/or with a material having a colorimetric deviation of less than 10% from the plate;
An opaque or colored adhesive film or an opaque or colored adhesive resin may be disposed on at least one of the main sides of said plate, plumb with the slot or gap between the periphery of the antenna substrate and the inner edge of the plate recess;
An opaque or colored adhesive film or an opaque or colored adhesive resin can be placed between the metal plate and one of the cover sheets; thus, the slots or gaps or discontinuities are less visible by transparency through the card body;
The card may comprise a colored layer or a layer of metal particles imitating the appearance of the metal plate on the slot filler material opening on the card edge.

### DESCRIPTION OF FIGURES

FIG. 1A shows a step of manufacturing a radiofrequency card undergoing assembly, with a space 7 for receiving the relay antenna 5 (or alternatively a direct antenna of the transponder 5B) according to one embodiment of the invention;

FIG. 2 is a cross-sectional view of a card similar to the one 1A in FIG. 1 showing a metal plate 4 being assembled onto cover sheets;

FIG. 3 shows a cross sectional view of an example card 1A obtained according to a first embodiment, which may comprise the elements of FIG. 1, after insertion or assembly of a transponder module 10 and a module comprising the relay antenna;

FIG. 4 shows a cross sectional view of a second example card obtained according to a second embodiment, which may comprise the elements of FIG. 1, after insertion or assembly of a transponder module 3 and a module comprising the relay antenna;

FIG. 5 shows steps of the method of the invention according to the first embodiment according to FIGS. 2 to 3;

FIG. 6 shows a hybrid card structure (contact and contactless) obtained according to a third embodiment with a relay antenna block inserted in a metal plate;

FIG. 7 shows a purely contactless card structure obtained according to a third embodiment with a block comprising a relay antenna and a radiofrequency chip module inserted into a metal plate.

FIG. 8 shows a relay antenna block 5 (or alternatively radio frequency transponder antenna with an ohmic connection 5B) with a module slot 40 (hybrid or purely contactless);

FIG. 9 shows a single metal plate with a slanting slot similar to that in FIG. 1;

FIG. 10 shows a step of assembling the antenna support substrate 55 with its protrusion 11E into the plate 4 and the cover sheets;

FIG. 11 shows a step of forming a plurality of antenna substrates 5 (or other electrical/electronic circuits) on a main substrate;

FIG. 12 shows a step of forming a plurality of radio frequency transponder antenna 5B substrates with its interconnect pads (or other electrical/electronic circuits) on a main substrate 50.

### DESCRIPTION

In general, identical or similar references from one figure to another represent an identical or similar element.

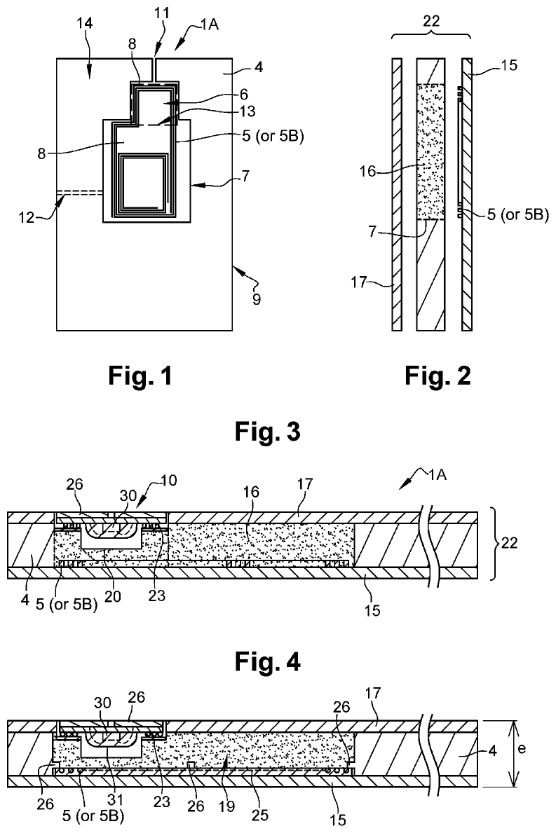

FIG. 1 shows a step in the method for manufacturing a radiofrequency smart card.

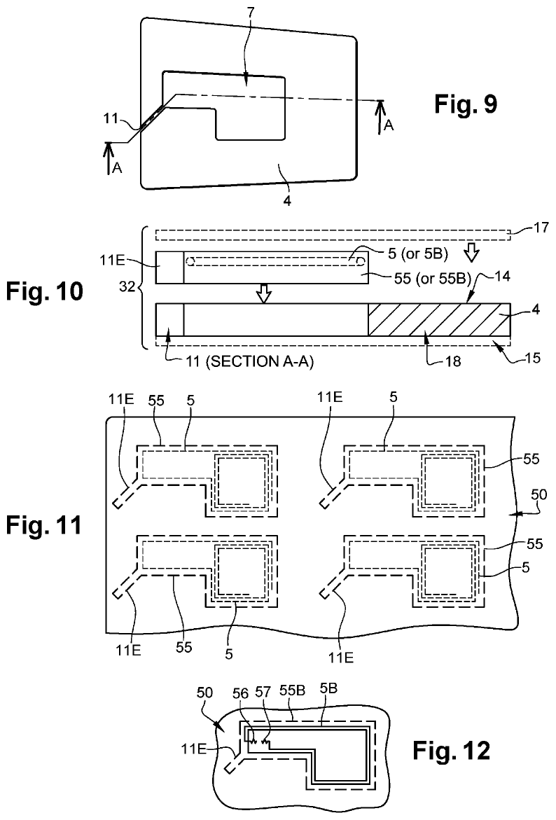

The method comprises, according to one embodiment, forming a card body metal insert 1A having a relay antenna 5; Alternatively, the antenna may be a normal radio frequency transponder (or chip) antenna 5B for direct connection to a radio frequency chip (FIG. 9). Connection pads from the antenna to a radio frequency module or chip can be arranged on the antenna support substrate.

The method further includes a step of arranging a radio frequency antenna and chip module 10 on the card body in a slot 6 facing the relay antenna 5 for radio frequency coupling. Alternatively, the module can be placed opposite the connection areas of an antenna 5B for direct electrical connection with the radio frequency transponder module 10, whether or not it has an antenna on the module.

For example, the module with antenna can be connected to an antenna extension arranged on the antenna substrate accommodated in the recess (or cavity of the metal plate) to increase the antenna inductance of the module. Alternatively, a module without antenna (but with radio frequency chip) can be connected to an antenna arranged on the antenna substrate housed in the metal plate recess. A single radio frequency chip can be connected to the antenna substrate housed in the plate cavity.

In the example, the insert 1A comprises or is formed of a metal plate 4. Alternatively, it could comprise several stacked plates (or other metal elements) assembled together. The edge 9 of the plate 4 is preferentially intended to be visible from outside the card body 22 (FIGS. 2, 3).

A relay antenna 5 (or transponder antenna 5B) is arranged in the card body, particularly in a corresponding space in the metal insert. However, it can be placed opposite a corresponding space cut into the plate(s).

A radiofrequency antenna and chip module can be arranged in the slot 13 on the card body opposite the relay antenna for radiofrequency coupling.

Alternatively, the module 10 can be directly arranged on the relay antenna (or its supporting substrate 15).

We will see later on different possibilities to arrange the transponder module 10 in relation to the relay antenna 5 and/or the card body 22.

Alternatively, a chip module without antenna can be inserted into a cavity opposite the interconnect pads 56, 57 of an antenna 5B (FIG. 9).

According to one characteristic, the method comprises the step of forming in the insert a space 7 permeable to the radiofrequency field, opening on at least one main face 14 of the insert, said space being configured to fit the dimensions of said relay antenna 5 (or antenna 5B) to receive it inside and/or opposite this space.

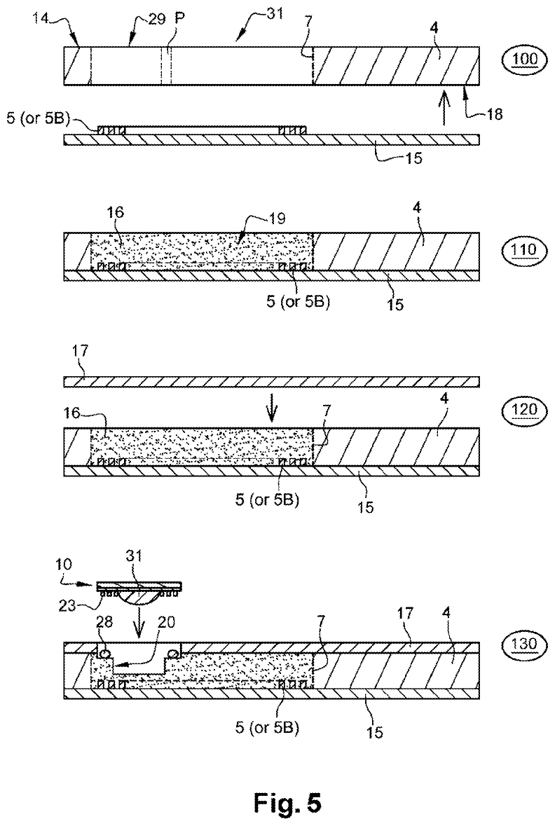

In the example of FIG. 1, (corresponding to step 100, FIG. 5) the space 7 was machined by stamping or milling into the metal plate 4.

The method can provide for the production of a single plate 4 or a series of plates on a large metal plate (or a metal strip) which will then be cut or stamped to extract each plate.

The permeable space 7 may be in the form of a first recess (or housing) 6 in a transponder coupling area in line with the slot 8 of the radiofrequency transponder 10 and a second recess 8 extending towards the center of the plate from the first recess 6. The two recesses can preferably communicate with each other, but this is not essential. There can be a separation between the two, for example a metal barrier of the plate 4.

The space or recess 7 is permeable because it is free of metal following its removal by machining.

The space 7 is machined or dimensioned so as to correspond substantially to the dimensions of the relay antenna 5 (or normal transponder antenna 5B directly connecting by contact or solder the pads of a radio frequency chip). The relay antenna 5 can be comprised in the space 7 (as with a relay antenna module inserted in the space (FIGS. 3 and 4) (The same is true for the direct-connection antenna 5B); Alternatively (not shown), the relay antenna can be outside this space while facing it (particularly for an antenna embedded in a sheet 15 assembled onto the plate 4).

The plate 4 comprises a slot 11 intersecting (or interrupting) the plate through its thickness and extending from an outer periphery (or edge) 9 of the plate to an inner periphery of said space 7 (or 8) permeable to the radiofrequency field.

However, thanks to the performance of a relay antenna associated with the transponder module, this slot 11 (or air gap) might make it possible to better satisfy banking standards for performance. The slot may allow better performance in general, whether with an inductively coupled relay (amplifier) antenna or with a directly electrically connected transponder antenna 5B.

The slot can make it possible, depending on its configuration in the plate and the coupling and/or frequency tuning with the transponder antenna, to form an amplifying relay antenna with the loop of the plate.

Thus, it is possible to place a radio frequency transponder (chip connected to an antenna) coupled to an amplifying relay antenna (loop formed by the slotted plate) into the recess 7 of the slotted plate radially to the recess. The slot in the plate can be a capacitor for the inductance formed by the loop plate. The loop thus formed can constitute an amplifying antenna for radio frequency communication.

A resonant effect can be achieved by tuning the loop (forming a turn and capacitor at the slot) as a resonant circuit configured to resonate with the radio frequency transponder circuit housed in said radio frequency-permeable space (or antenna substrate receiving slot).

Another alternative slot 12 (or one additional slot relative to slot 14), may open into the second recess.

A gap may exist between the inner edge of the recess 7 and the periphery of the antenna 5 or 5B support substrate 25 or 55.

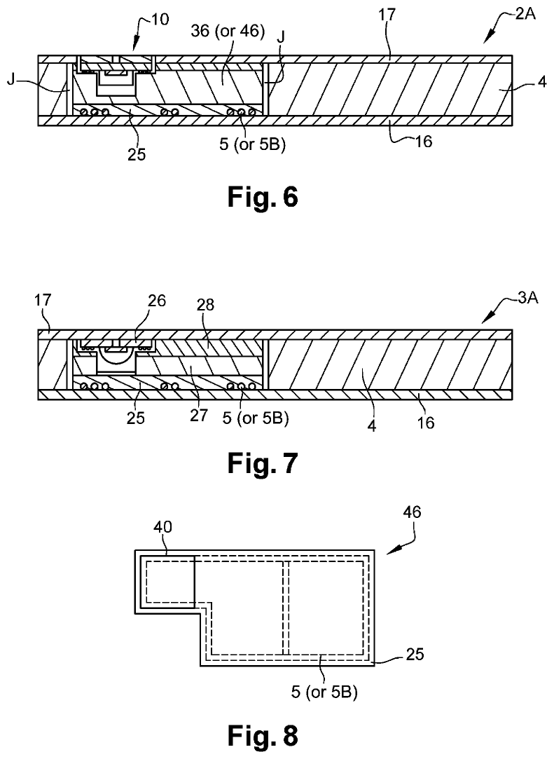

This gap J (FIG. 6) can be seen through the main face of the card body in the same way as the slot it extends through the loop 4 (FIG. 6).

According to an additional feature for all examples, the method may provide for covering said space 7 with a filler material 16 and assembling a cover sheet 15 (and/or 17) onto at least one main face of the insert.

In the example shown in FIG. 5, corresponding to step 100, a sheet 15 comprising the relay antenna 5 (or alternatively 5B) may be laminated and/or bonded to the metal plate after it has been hollowed out to form the space 7.

Another sheet 17 can be assembled (step 120) on the opposite face 18 of the plate 4 from that receiving the first sheet 15, after the filler material 19 has been deposited in the space 7.

The space 7 can be filled with a filler, stuffing material 19 such as a polymer resin.

Alternatively, the thick cover sheets 15, 17 may provide material intended to flow into the space or gap J to fill it during a pressing and heating of these sheets. Advantageously, this material can be opaque or have an opacity or color or chromaticity close to that of the metal plate.

Alternatively, the material 19 can be introduced into the space 7 via a hole in one of the two sheets 15 or 17 or via a slot 11 or 12 (FIG. 1).

According to the formula ΔE94, (or DE94) adopted by the C.I.E. in 1994, the preferred colorimetric deviation ΔE94 for the implementation of the invention whatever the embodiment can be lower than 4%, even lower than 10%.

According to one characteristic, the relay antenna 5 (or normal antenna 5B) can be realized on a support substrate 15, 25 as in FIG. 2, 4 or 5 and then the antenna (5 or 5B) substrate is inserted into the permeable space.

In FIGS. 2, 3 and 5, the substrate sheet 15 is assembled onto the underside 18, extending the thickness of the plate.

On the other hand, in another embodiment (FIG. 4), the substrate 25 may have dimensions substantially smaller than the dimensions of the cavity 7 and can therefore be inserted into the thickness “e” of the plate 4;

Alternatively, the relay antenna 5 (or 5B) may not be formed on a substrate but may be pre-cut from metal and then placed in the cavity 7 on an insulating plate bottom (for example, a sheet 15 without an antenna preformed on it).

The antenna can be formed using any antenna forming technology known to the skilled person, in particular by printing or jetting conductive material, or etching.

In FIG. 4, the substrate 25 carrying the relay antenna 5 (or alternatively 5B) may be wedged into the space 7 with the help of protrusions or shoulders 26 extending from the inner side of the space 7 towards the inside of the space.

The space 7 can thus be configured to form a wedge plane for a support substrate 25 of the relay antenna 5 (or 5B) within the thickness of the insert or plate 4.

Here the antenna 5 (or 5B) may be ultrasonically embedded in the support substrate 25. And another cover or decorative sheet 15 is assembled to cover the opening of the space 7 over the relay antenna 5 (or 5B) substrate.

In step 130, (FIG. 5), the method may include forming a cavity 20 (or slot) receiving a radiofrequency transponder module 10 and then embedding the module in its slot 6, 13 for inductive coupling with the relay antenna 5 (or alternatively a direct ohmic connection in the case of an antenna 5B).

FIG. 3 shows a smart card insert or radiofrequency smart card 22. The card comprises a card body insert 22 with a relay antenna 5 and a module 10 equipped with a radiofrequency module antenna 23, arranged on the card body 22, facing the relay antenna 5 for radiofrequency coupling therewith; Alternatively, the antenna may have a direct ohmic connection 5B and the module may be without a transponder antenna).

The card further comprises a space 7 permeable to the radiofrequency field, formed in the metal plate 4 and opening onto at least one main face of the metal plate; The space is configured to the dimensions of the relay antenna 5 (or antenna 5B) to receive it inside and/or to be opposite the relay antenna (or antenna 5B);

The card may further comprise a filler material 16 or 19 covering the space 7. The card may comprise, alternatively or cumulatively to this material 16, 19, a cover sheet 17 assembled onto at least one main face 14 of the insert 22 or of the plate 4.

FIG. 4 differs from the previous figure in that the relay antenna (or alternatively direct-connection antenna 5B) substrate 25 is inserted into the thickness “e” of the metal plate 4. The substrate 25 normally receives another cover sheet 15 on its outer face.

In FIG. 3, the antenna is formed or supported directly on the cover sheet or outer sheet 15 for ease of implementation.

According to an advantageous characteristic, the invention may provide for the separate realization of a “tag” assembly (block or radiofrequency transponder assembly) comprising an assembling of the relay antenna 5 (or antenna 5B) with the radiofrequency module (with or without an edge antenna); Then this “tag” assembly is inserted into the space 7. The assembly may or may not comprise ferrite. Such a tag is disclosed by the applicant under the reference Thales DIS/0159GCTA.

The tag may preferably comprise a purely radiofrequency module without contact pads 26.

Such a tag may comprise a block structure comprising the relay antenna 5 (or antenna 5B) embedded in an insulating body and a radiofrequency module inductively coupled to this relay antenna (or ohmically connected to an antenna 5B with interconnect pads 56, 57).

This block can be cut or shaped to the dimensions of the space 7 and then inserted into space 7 of plate 4. Then, a cover sheet can be assembled on each face 14, 18 of the plate, in particular with the help of a resin which can glue the sheets and fill the gap (J) between the block “tag” structure and the internal edges of the space 7 (FIG. 6).

The relay antenna 5 (or 5B) may preferably be an optimized antenna configured without a capacitor plate, with a second loop (or spiral) entangled in a first loop (or spiral) in the opposite direction. The principle of such an antenna is described in the international patent application WO2016188920; The structures corresponding to the different variants described in this international application are integrated in the present application.

The relay antenna may have a total area of between ⅓ and ¼ of the main area of the card.

The relay antenna may for example have a total area equal to 6 or 7 times the area of the antenna 23 of the module.

A radiofrequency module 10 according to the invention may comprise those known from the field of smart card.

A smart card module may comprise an insulating substrate, a radiofrequency transponder comprising the chip 30 and the module antenna 23. These radiofrequency smart card modules are generally embedded in a cavity 20 of the card body 22. The radiofrequency chip 30 and its connections to the module antenna may be encapsulated with protective material or resin 30.

Alternatively, the module may have a thinner structure if manufactured like that of an RFID tag.

Alternatively, the module can just carry the radio frequency or hybrid chip without the transponder antenna.

The invention may have the advantage of reusing a known structure of a (mini) tag to insert it such as in a space in a metal plate 4 and thus form a heavy-duty metal contactless card with good radiofrequency performance.

The performance is substantially the same as the tag alone since the space of the tag in the plate 4 is permeable to the electromagnetic field.

In FIG. 6, a metal card 2A is shown which differs from the structure of FIG. 4 in that the relay antenna 5 (or alternatively 5B), or its supporting insert or substrate 25, is joined to a polymer block or polymer card body 36 (or 46) prior to its assembly into the card 2A.

The insert or block 36 may have an gap J in its joining with the plate 4. This gap can be filled either by lamination or by adding resin or adhesive to join the cover sheets 16, 17.

The antenna module 10 is mounted as in FIG. 3 or 4.

The block 36 (or 46) (FIG. 8) can then be cut or extracted (to the dimensions of the cavity 7 of the plate 4, especially by punching) from a large sheet comprising a plurality of relay antennas as in FIG. 11. FIG. 8 may show the relay antenna 5 (or the antenna 5B) either on a substrate 25 or on a block 46 (5, 25, 36) comprising an insulating material 36 joined to the relay antenna 5 (or antenna 5B) substrate 25.

Alternatively, according to a practical embodiment, the relay antenna 5 (or antenna 5B) can be formed on (or embedded in) a substrate or block of polymeric material (moulding resin) or any material permeable to electromagnetic fields and whose dimensions substantially correspond to or are slightly smaller than those of a recess (or cavity) 7 in a metal plate 4.

As an alternative to FIG. 6, a further embodiment is shown in FIG. 7 which differs from FIG. 6 in that the relay antenna block (or antenna 5B) 46 itself comprises a purely radiofrequency module (without external contact pads 26).

The relay antenna (or antenna 5B) block 46 may comprise a ferrite core 27 assembled between the relay antenna substrate 25 and an insulating sheet or layer, particularly a polymeric one 28. This core may extend over the entire surface of the insert 46. There may be a cavity for receiving a purely contactless module portion 40 provided in this ferrite core or plate.

All or part of this block 46 can include ferrite, in particular between layers 25 & 26 (for greater coupling between the relay antenna and the transponder).

The radiofrequency transponder chip module 40 can be mounted on an insert 36 or 46 of the relay antenna (or antenna 5B), itself before or after being assembled in or with the metal plate.

The relay antenna 5 (or antenna 5B) can be placed bare in the second cavity or recess of the plate and then covered with resin.

It can be formed on a dielectric substrate, in particular by electrochemical etching, like a smart card module on a dielectric insulating tape.

The relay antenna 5 (or 5B) can preferably be manufactured or configured to form a capacitor due to the interleaved turns.

Alternatively, the relay antenna 5 (or 5B) may include a capacitor in the form of an integrated circuit component or SMD (surface mount circuit). The advantage is to confine the capacitance function within a small circuit (instead of capacitor plates which can disturb the electromagnetic field reception) to keep an electromagnetic permeability of the material located in the coupling surface of the relay antenna (or antenna 5B). Historically, a base station antenna had capacitor plates large enough to form a capacitor (patent EP1031939 (B1).

The invention optimises the maximum weight of the metal plate of a metal smart card. It makes it possible to maintain a maximum weight and optimised radiofrequency performances.

The published prior art did not make it possible to have such heavy-duty metal cards with sufficient performance to satisfy communication standards, notably ISO 14443 & EMVCO. This cards also required making a slot 11 (or air gap) extending from the edge of a plate to a receiving space of an antenna module or the cavity 7 (slot 12).

FIGS. 9 and 10 show a step in the method for manufacturing a radio frequency smart card 1A according to an embodiment comprising a slot 11 in a metal plate 4. (FIG. 9 is similar to the one in FIG. 1).

The card to be manufactured comprises a card body (similar to that 22 of FIG. 2 or 32 of FIG. 10) and containing a metal plate 4 looped around a recess or receiving space of an antenna and a substrate (or carrier). The plate can have different peripheral contour shapes and the cavity can also have various shapes. The important thing is to have a metal plate surrounding the space or cavity. The plate according to the invention comprises a separation or interruption in the peripheral path of the plate in order to form an electrically conductive loop around the recess (or cavity or housing 7). The card comprises a slot 11 extending through the loop 4. The slot interrupts the loop over the entire width of the loop. The gap passes through the thickness of the plate.

The card further comprises an outer polymeric layer 17 and 15, each covering one of the main faces 14, 18 of said plate. The edge 9 of the plate 4 is also preferentially intended to be visible from outside the card body 32 (like the body 22).

According to one feature, the method may comprise one of the following steps:
filling the slot 11 or the gap J with a material having an opacity coefficient close to that of the metal plate. This solution is advantageous especially to avoid visual defects by transparency or when the slot does not open on the edge, the metal plate not extending to the peripheral edge of the card.
or filling or masking of the gap with a material having an L.A.B of at least 80% of the L.A.B of the metal plate or having a color difference DE*94 of less than 4% or 10%. This solution is advantageous especially in the case where a slot opens on the edge of the card in order to avoid seeing a difference in color (or chromaticity) or appearance, at least on the edge of the card.

However, in all examples, improvements mitigating appearance defects can be seen by having an L.A.B of the antenna support (relative to that of the metal plate) greater than 60% or 70% or ideally greater than 80% or 90% until it is perfectly tone on tone with an L.A.B of 100%, depending on the desired visual quality.

These same coefficient values from 60% to 100% can also be applied with respect to the criterion of the opacity of the antenna support with respect to the opacity of the plate. In all examples, the opacity value of the antenna support (antenna insert or inlay) is at least 80% of the opacity value of the metal plate.

Thus, seen from the outside, the card's edge appears homogeneous. Also, seen through transparency, the crack is less visible.

As this is a stainless steel plate, the invention provides for the use of a gray material rather than white.

Different manufacturing methods have been selected by the inventors for their advantages.

According to one feature, the method comprises the steps of inserting a radio frequency antenna interface support substrate within said loop and a polymeric filler material within said slot.

Indeed, the method can provide for filling the slot independently or not of the recess or space 7 for receiving the antenna. For example, the space 7 may be filled in accordance with the various modes of the preceding figures while the slot is filled with a material distinct from the one in the receiving space 7 by any known method.

This may include material delivery by syringe or the like in liquid form, or insertion of a rod the width and depth of the slot independently of the antenna substrate (particularly 25). The material is preferably of the same color (or chromaticity) as the metal plate or loop 4.

In order to prevent the slot from being visible through the window, the material can also have an opacity close to that provided by the metal plate.

According to another feature or embodiment, the filler material (polymer or otherwise) may be obtained by cutting the support substrate with a peripheral protrusion 11E forming a tongue from an intermediate support substrate 50. The position and shape of the protrusion 11E corresponds to the position and shape of the slot so as to fill it when the support substrate 55 is inserted inside the recess 7.

This mode is shown in FIG. 11. In a first step, a plurality of antennas 55 is realized on a main or intermediate support substrate 50 by any known means of antenna realization (inlaying of conductive wire by ultrasound or screen printing, engraving, etc.).

Then the method provides for a cutting or extraction of each antenna substrate 55 with its antenna 5 and its tongue-shaped protrusion 11E whose shape and thickness correspond to those of the slot 11. The cutting or extraction can be done by laser, punching, stamping, etc.

The step of extracting or cutting the tongue integral to the substrate, in the method for manufacturing a smart card, can be carried out independently of the color (chromaticity) or the nature of the material composing the substrate.

The above method can be independent of the previously mentioned issue of the card slot's appearance.

This smart card manufacturing method, regardless of the color (or chromaticity) or nature of the material, can be applied to all the slotted embodiments described in this description.

In FIG. 10, the method involves inserting each antenna support substrate 55 with its filler protrusion 11E, into a recess or receiving space 7 extended by a slot 11.

If necessary, the antenna can be produced by any known means after forming (especially cutting, molding) the antenna substrate to the correct dimensions of the receiving cavity of the substrate.

The antenna can be realized in particular once the substrate is transferred into the cavity by any known means such as wire inlay, screen printing, engraving, and metal spraying.

In FIG. 10, the method involves inserting each antenna support substrate 55 with its filler protrusion 11E, into a recess or receiving space 7 extended by a slot 11.

After insertion, the method may preferably include the addition of cover sheets 14 and 17 on opposite sides of the metal plate 4.

The assembly can be hot-laminated or with a hot melt and/or thermosetting adhesive adhering the plate to the outer sheets 15, 17. During lamination, the support substrate 55 may be selected or configured in dimensions (thickness, width, length volume and material (for example, hot melt or heat curable polymer) to flow into the gap 7 and extend to the recess edge or gap 7.

The edge of the card can be mechanically polished to remove any burrs, runs, etc. following the lamination (or lamination operation).

Thus, with a choice of material close to the opacity of the metal plate and flowing to the edge of the gap, any discontinuities or gaps between the inner edge of the plate and the antenna support substrate are not visible by transparency.

According to another feature or embodiment, an opaque film may be disposed in line with the slot 11 on at least one side of said plate. The slot can be at least partially filled to complete the thickness and/or length of a growth lodged therein.

The slot may be so fine and require so little volume of filler material that the layer flowing material disposed on the metal surface is sufficient to fill it or fill in a protrusion that would occupy a partial volume of the slot along the length or thickness.

In the example, a portion of opaque film may be placed and extend locally opposite the slot 11. The slot 11 can be filled by the flow of the cover sheet material 15, 17 or via the material of an adhesive sheet or adhesive film or adhesive resin between the plate and the sheets 14, 17. The material of the adhesive or filler sheet, film or resin may have desired properties of color or chromaticity and/or opacity close to that of the metal plate or as explained for protrusion 11E.

If necessary, the edge of the protrusion opening onto the edge of the card can be colored, especially by inkjet printing.

A set of cards, forming a batch, can be presented to a printer with the cards tightly packed together in order to perform a graphic print on all the cards in the batch in a single operation.

The color (or chromaticity) can be chosen as close as possible to the appearance of the metal.

If necessary, the method may include printing metal particles that are close in appearance to the metal to be imitated that makes up the metal plate.

In FIG. 12, the antenna substrate 55 to be cut differs from those in FIG. 8 in that the antenna 5B is intended to be directly connected (ohmically or electrically) to an integrated circuit (or electronic) chip module when embedded in a cavity in the card body. The antenna comprises end portions 56, 57 connecting to an electronic chip module which are updated when a cavity is made on the main surface of the top sheet 17 of a card.

This form of antenna 5B can replace the relay antenna 5 of all the previous examples or embodiments, especially FIGS. 10 and 11.

Alternatively, the antenna substrate with a tongue-shaped protrusion can be obtained by molding.

The antenna can be etched, inlaid or screen printed or deposited by printing, in particular, with conductive material on the antenna substrate.

Alternatively, the antenna substrate with its tongue can be overmolded onto a preformed antenna. For example, the antenna can be placed at the bottom of the metal plate recess and a resin can be poured into the recess which serves as a molding space.

In all of these examples, the tongue may have a homogeneous continuity of material at its junction with the antenna substrate.

Furthermore, the invention can use a “L.A.B” model, which is a model of color representation developed in 1976 by the International Commission on Illumination (CIE): “L” represents the brightness, which ranges from 0 (black) to 100 (white).

“A” represents the range of the red (positive value)→green (negative) axis through the gray (0).

“B” represents the range of the yellow axis (positive value)→blue (negative) through the gray (0).

The values (positive or negative) of L.A.B given according to the invention may preferably apply to each component L, A and B. In particular, the value of B must be at least 80% of the B value of the plate. The same is true for L and A.

However, the value of the percentage can be different for each component, for example more than 80% for A and B and a little less, for example 65% for clarity L.

The important thing may be to mitigate the visual defect by having the antenna support look different from the light colored or even white antenna supports currently used.

Thus the gray color targets as being close to a Pantone 877. Pantone which can be defined as follows in terms of L.A.B in a color space L.A.B CIELAB L>55; 0.5<A<1.5; 0.5<B<2.

1. A method for manufacturing a smart card comprising the step of forming a card body containing a metal plate forming a loop around a recess for receiving an antenna substrate, a slot extending from the recess to the periphery of the plate through the loop or the plate, said slot being filled with an insulating filler material,
wherein said insulating filler material is obtained at least partly by a material of a tongue-shaped protrusion of the antenna substrate and formed with said antenna substrate before its insertion into the card.

2. The method according to claim 1, wherein said tongue-shaped protrusion attached to the antenna substrate is cut with said antenna substrate from an intermediate main substrate.

3. The method according to claim 1, comprises a step of inserting the substrate of antenna into the recess and inserting the tongue into said slot in a single operation.

4. The method according to claim 1, comprises a step of placing the plate on the antenna substrate such that the plate recess receives the antenna substrate therein and said plate slot receives the tongue therein, in a single operation.

5. The method according to claim 1, wherein said slot is filled by a material having an opacity coefficient close to at least 80% of that of the metal plate and/or by a material having a colorimetric deviation less than 10% of that of said plate.

6. The method according to claim 1, wherein a film or an adhesive or a resin having an opaque material or being of a color close to that of the metal plate is arranged plumb with the slot or a gap on at least one of the main sides of said plate.

7. The method according to claim 1, comprises the steps of:
forming a metal insert of the card body containing said plate in the form of a loop around a recess permeable to the radio frequency field opening onto the two main faces of said plate, said plate extending or not to at least one of the edges of the card,
inserting a relay antenna or a transponder antenna into and/or opposite that space,
arranging a module equipped or not with a radio frequency module antenna, on the card body opposite the relay antenna or transponder antenna connection pads for a radio frequency coupling with the relay antenna or for an electrical connection with the transponder antenna.

8. The method according to claim 7, wherein the relay antenna or transponder antenna is realized on said intermediate support substrate with a plurality of relay antennas or transponder antennas, each relay antenna or transponder antenna being subsequently individualized with its own support substrate and said tongue-shaped protrusion, by extracting or cutting from the intermediate main antenna substrate.

9. The method according to claim 7, comprises a step of covering each opposite main face of said plate with an external covering layer.

10. An antenna substrate configured to be inserted into a radio frequency smart card recess, said recess opening onto a periphery of the smart card through a slot, said smart card comprising a metal plate forming a loop around the recess, said slot extending from the recess to the periphery of the metal plate through the loop or the metal plate,
wherein said antenna substrate comprises a tongue-shaped protrusion to provide at least material to at least partially fill said slot and to form a homogeneous continuity of an antenna support substrate material.

11. A smart card comprising an antenna substrate inserted into a recess of said smart card, said recess opening onto a periphery of the card through a slot, said antenna substrate comprising a tongue-shaped protrusion attached to the antenna substrate being inserted into said slot
said tongue-shaped protrusion providing at least material to at least partially fill of said slot and to form a homogeneous continuity of an antenna support substrate material.

12. The card according to claim 11, wherein said slot is filled with a material having an opacity coefficient close to at least 80% of that of the metal plate and/or by a material having a colorimetric deviation less than 10% of that of said plate.

13. The card according to claim 12, wherein an opaque or colored adhesive film or an opaque or colored adhesive resin is arranged plumb with the slot or a gap on at least one of the main sides of said plate.

14. The card according to claim 12, wherein the opaque or colored adhesive film or an opaque or colored adhesive resin is arranged between the metal plate and one of the cover sheets.

15. The card according to claim 12, comprises a colored layer or a layer of metallic particles imitating the appearance of the metal plate on the material filling the slot opening on the edge of the card.
